(19) United States
(12) Patent Application Publication
(10) Pub. No.: US 2006/0208432 A1
(43) Pub. Date: Sep. 21, 2006

(54) Self-centering four-jaw chuck

(75) Inventor: Johann Taglang, Medlingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ROHM GmbH & Co. KG

(21) Appl. No.: 11/377,009

(22) Filed: Mar. 16, 2006

(30) Foreign Application Priority Data
Mar. 19, 2005 (DE) 202005004471.7

(51) Int. Cl. B23B 31/12

(52) U.S. Cl. 279/58

(57) ABSTRACT

A chuck has a chuck body centered on and rotatable about a body axis, two first jaws diametrally flanking the body axis, each formed with an angled actuation face, and radially shiftable in the chuck body, and two second jaws diametrally flanking the body axis, each formed with an angled actuation face, interleaved with the first jaws, and radially shiftable in the chuck body. An inner sleeve engages the actuation faces of the first jaws and is axially shiftable to radially shift the first jaws, and an outer sleeve engages the actuation faces of the second jaws and is axially shiftable to radially shift the second jaws. An axially shiftable actuation element carries a pivotal force-transmitting rocker having inner and outer ends operatively engaging the respective inner and outer sleeves for axially shifting the inner and outer sleeves on axial shifting of the element while permitting limited axial movement of the inner and outer sleeves relative to each other.

### FIELD OF THE INVENTION

The present invention relates to a chuck. More particularly this invention concerns self-centering four-jaw chuck.

### BACKGROUND OF THE INVENTION

A standard chuck has such as used in a lathe has an annular body entered on an axis and holding a plurality of jaws angularly equispaced about the axis and movable radially by an actuation element that itself is typically movable axially and coupled by angled faces to the jaws. When the actuation element is shifted axially in one direction the jaws move synchronously radially inward to grip and hold a tool or workpiece on the axis and when the element is moved axially in the opposite direction the jaws move radially outward to release the tool or workpiece.

In a standard system there are three jaws so that a round-section tool or workpiece can be easily gripped, as can in fact a hexagonal-section workpiece. The jaws are moved identically radially so that, as they close, they center the tool or workpiece.

In a four-jaw chuck the system is typically the same, with the jaws moving radially identically. Such a chuck is good for holding a square-section workpiece.

A problem is encountered with a nonsauare but rectangular-section tool or workpiece must be held in the chuck. In this case when two opposite jaws come to bear on the two more widely spaced sides of the workpiece, they stop and further tightening is impossible, so that the other two jaws never touch the workpiece and in fact the workpiece is not even centered in a direction perpendicular to its long sides. To grip such a workpiece it is necessary to use shims or spacers or replace two of the jaws with thicker jaws, a difficult and unsatisfactory solution.

### OBJECTS OF THE INVENTION

It is therefore an object of the present invention to provide an improved chuck.

Another object is the provision of such an improved chuck that overcomes the above-given disadvantages, in particular that can center and grip rectangular-section tools or workpieces of different dimensions.

### SUMMARY OF THE INVENTION

A chuck has according to the invention a chuck body centered on and rotatable about a body axis, two first jaws diametrally flanking the body axis, each formed with an angled actuation face, and radially shiftable in the chuck body, and two second jaws diametrally flanking the body axis, each formed with an angled actuation face, interleaved with the first jaws, and radially shiftable in the chuck body. An inner sleeve engages the actuation faces of the first jaws and is axially shiftable to radially shift the first jaws, and an outer sleeve engages the actuation faces of the second jaws and is axially shiftable to radially shift the second jaws. An axially shiftable actuation element carries a pivotal force-transmitting rocker having inner and outer ends operatively engaging the respective inner and outer sleeves for axially shifting the inner and outer sleeves on axial shifting of the element while permitting limited axial movement of the inner and outer sleeves relative to each other.

Thus with this system it is possible to clamp nonsguare but rectangular workpieces in a manner identical to that used to clamp circular-section workpieces in a three-jaw chuck. The provision of the rocker permits some relative axial movement of the inner and outer sleeves which is translated into relative radial movement of the jaws. Thus when the chuck is tightened one two opposite jaws is going to come to bear on one of the more widely spaced short sides of the workpiece, pushing it toward the opposite jaw and centering the workpiece diametrally parallel to its long sides. Once these two jaws are seated on the more widely spaced opposite sides of the workpiece, they will not move inward any more, and the rocker will tip so that the movement of the actuation element will be transferred only to the other two jaws. One of these other two jaws will come to rest against one of the broad sides of the tool or workpiece, shifting the workpiece diametrally to center it until it is pressed against the opposite jaw. Once this position is reached, with all four jaws bearing on respective faces of the workpiece, the workpiece is perfectly centered and further movement of the actuation element will merely serve to press them all synchronously with the same force against the respective faces. Thus centering and clamping of a nonsquare but rectangular-section workpiece or tool is simple and automatic, effected through a simple but reliable mechanical system.

The chuck body forms a pressurizable chamber and the actuation element is a sleeve having a collar forming a piston in the chamber. The piston has a radially projecting rim dividing the chamber into separate front and back compartments that can be pressurized alternately by an appropriate hydraulic controller.

The actuation-element sleeve is coaxial with and between the inner and outer sleeves. In addition the inner and outer sleeves respectively have outer and inner cylindrical surfaces sliding on the actuation-element sleeve. The outer sleeve has an outer cylindrical surface sliding on the chuck body. Thus the entire assembly is quite compact.

The jaws in accordance with the invention are releasably mounted on the inner and outer sleeves. They can be made of a soft metal to avoid damaging the tool or workpiece.

The rocker according to the invention extends generally radially and has a center part pivoted in the actuation element, an outer end part pivoted in the outer sleeve, and an inner end part pivoted in the inner sleeve. The center part pivots about a rocker axis lying generally in a plane perpendicular to the body axis and tangential to a circle centered on the body axis and lying in the plane. In addition the center part and the end parts of the rocker each have a part-spherical outer surface. The inner and outer sleeve and actuation element are formed with radial generally cylindrical bores holding the respective parts of the rocker. At least the bore of the actuation sleeve is throughgoing. For maximum force balancing and force transmission there a plurality of such rockers angularly distributed about the sleeves.

To keep chips and the like out of the chuck there is an elastic seal engaged around the jaws. This seal is vulcanized to the jaws.

### BRIEF DESCRIPTION OF THE DRAWING

The above and other objects, features, and advantages will become more readily apparent from the following description, reference being made to the accompanying drawing in which:

FIG. 1 is an axial section through the chuck according to the invention;

FIG. 2 is an end view taken in the direction of arrow II of FIG. 1;

FIG. 3 is a cross section taken along line III-III of FIG. 1; and

FIG. 4 is a longitudinal axial section taken along line IV-IV of FIG. 3.

### SPECIFIC DESCRIPTION

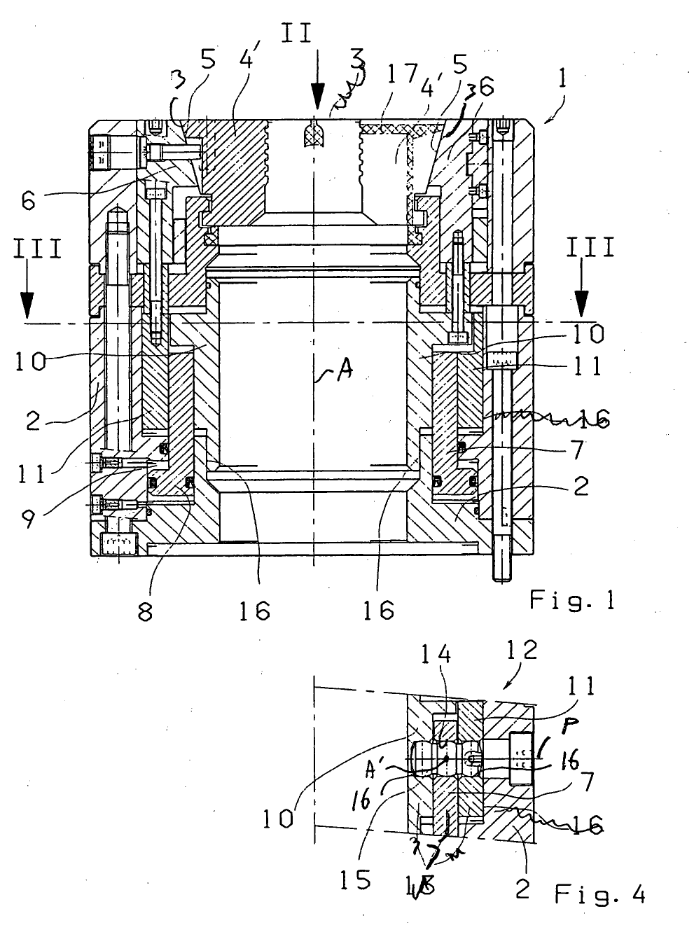

As seen in FIG. 1 to 3 a chuck 1 according to the invention has a chuck body 2 centered on and rotatable about an axis A. Four segmental jaws 4′ and 4″ are angularly equispaced about the axis A and have angled outwardly directed actuation faces 3 riding on angled inwardly directed faces 5 of respective actuator parts 6, with the jaws 4′ diametrally opposite one another and the jaws 4″ also diametrally opposed and interleaved with the jaws 4′. When the parts 6 are moved axially outward (upward in FIG. 1) the jaws 4′ and 4″ are moved radially inward toward the axis A, and when the parts 6 are moved axially outward the jaws 4′ and 4″ are moved radially outward. An elastomeric seal arrangement 17 closes gaps between the jaws 4′ and 4″ to prevent machining chips from getting inside the chuck 1.

An annular piston 8 axially shiftable in a hydraulically pressurizable double-acting chamber 9 (FIG. 1 only) in the chuck body 2 is connected to an axially centered actuation sleeve 7 extending axially outward toward the jaws 4′ and 4″. The parts 6 of the jaws 4′ are fixed axially to an inner sleeve 10 inside the sleeve 7, and the parts 6 of the jaws 4″ are fixed axially to an outer sleeve 11 outside the sleeve 7. The sleeves 7, 10, and 11 are at least limitedly axially shiftable relative to one another. The jaws 4′ and 4″ are releasably mounted on to the sleeves 10 and 11 so they can be replaced. Furthermore they can be set to move axially with the sleeves 10 and 11 when the move radially, or to move only radially.

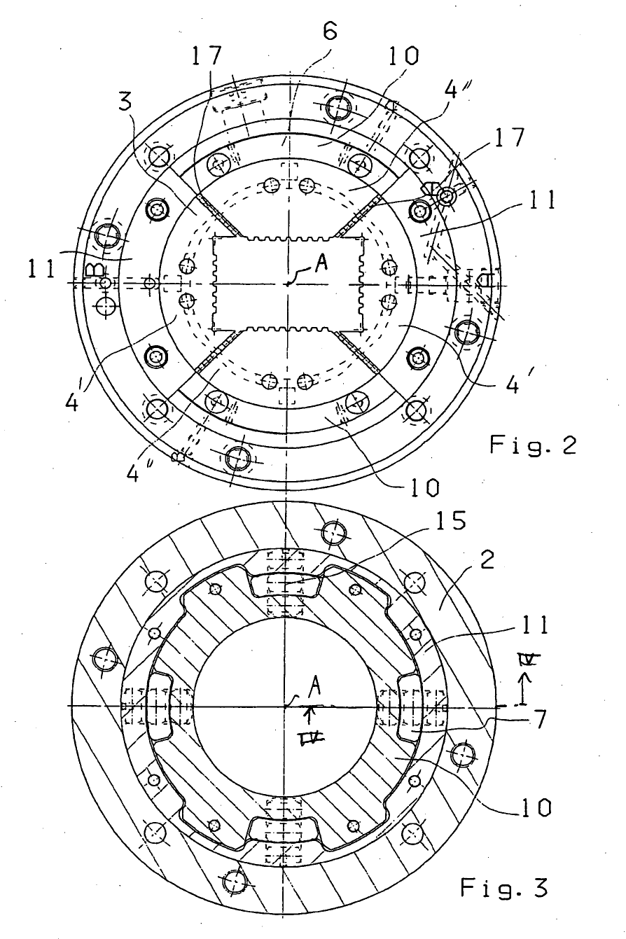

According to the invention as shown in FIG. 4 the actuation sleeve 7 is coupled to the sleeves 10 and 11 by at least one, here four, assemblies 12. Each such assembly 12 comprises a rocker 15 extending from a central seat 14 formed in the sleeve 7 into flanking seats 16 formed in the sleeves 10 and 11. The central part of each rocker 15 is spherically rounded and can pivot in the respective central seat 14 about a respective axis A′ lying in a plane P perpendicular to the axis A and extending tangentially to a circle centered on that axis A and lying in that plane P. The outer ends of the rocker 15 are similarly spherically rounded and can pivot in the seats 16. It is therefore possible as mentioned above for the two sleeves 10 and 11 to shift axially relative to each other and to the sleeve 7, but movement of the sleeve 10 always being axially opposite to that of the sleeve 11. Since the sleeves 10 and 11 are coupled via the respective parts 6 to the respective jaws 4′ and 4″, the jaws 4′ can also move limitedly radially relative to the jaws 4″.

With this system, therefore, when a rectangular-section workpiece is inserted axially into the space between the jaws 4′ and 4″, the sleeve 7 can be pushed axially outward by the piston 8 to shift all the jaws 41 and 4″ radially inward. So long as the jaws 4′ and 4″ meet no resistance, axial outward movement of the center sleeve 7 will be transmitted by the rockers 15 to the two flanking sleeves 10 and 11 that will therefore move axially synchronously outward.

When for instance the jaws 4′ come into contact with the outer surface of the workpiece before the jaws 4′, this action will have the initial effect of centering the workpiece between these jaws 4′. Once the workpiece is, however, gripped by both of the jaws 4′, they will be blocked from moving radially inward and, with them, axial outward movement of the respective sleeve 10 will be blocked. This action will therefore stop axial outward movement of the inner ends of the rockers 15 so that they will all tip and their outer ends will continue to move axially outward as the sleeve 7 advances. The result will be that then one of the jaws 4″ will engage the workpiece, pushing it to a central position until the other of the jaws 4″ engages it. Once in this position, further axial outward movement of the sleeve 7 will force all four jaws 4′ and 4″ inward, solidly locking the workpiece on center between these jaws 4′ and 4″.

Thus with the system according to the invention a square-section workpiece is automatically centered in the chuck 1 and held on center.

I claim:

1. A chuck comprising:
a chuck body centered on and rotatable about a body axis;
two first jaws diametrally flanking the body axis, each formed with an angled actuation face, and radially shiftable in the chuck body;
two second jaws diametrally flanking the body axis, each formed with an angled actuation face, interleaved with the first jaws, and radially shiftable in the chuck body;
an inner sleeve engaging the actuation faces of the first jaws and axially shiftable to radially shift the first jaws;
an outer sleeve engaging the actuation faces of the second jaws and axially shiftable to radially shift the second jaws;
an axially shiftable actuation element; and
means including a force-transmitting rocker pivotal on the actuation element and having inner and outer ends operatively engaging the respective inner and outer sleeves for axially shifting the inner and outer sleeves on axial shifting of the element while permitting limited axial movement of the inner and outer sleeves relative to each other.

2. The chuck defined in claim 1 wherein the chuck body forms a pressurizable chamber and the actuation element is a sleeve having a collar forming a piston in the chamber.

3. The chuck defined in claim 2 wherein the actuation-element sleeve is coaxial with and between the inner and outer sleeves.

4. The chuck defined in claim 3 wherein the inner and outer sleeves respectively have outer and inner cylindrical surfaces sliding on the actuation-element sleeve.

5. The chuck defined in claim 4 wherein the outer sleeve has an outer cylindrical surface sliding on the chuck body.

6. The chuck defined in claim 1 wherein the jaws are releasably mounted on the inner and outer sleeves.

7. The chuck defined in claim 1 wherein the rocker extends generally radially and has a center part pivoted in the actuation element, an outer end part pivoted in the outer sleeve, and an inner end part pivoted in the inner sleeve.

8. The chuck defined in claim 7 wherein the center part pivots about a rocker axis lying generally in a plane perpendicular to the body axis and tangential to a circle centered on the body axis and lying in the plane.

9. The chuck defined in claim 7 wherein the center part of the rocker has a part-spherical outer surface.

10. The chuck defined in claim 6 wherein the end parts of the rocker have part-spherical outer surfaces.

11. The chuck defined in claim 7 wherein the inner and outer sleeve and actuation element are formed with radially throughgoing generally cylindrical bores holding the respective parts of the rocker.

12. The chuck defined in claim 1 wherein there a plurality of such rockers angularly distributed about the sleeves.

13. The chuck defined in claim 1, further comprising
an elastic seal engaged around the jaws.

14. The chuck defined in claim 13 wherein the seal is vulcanized to the jaws.
